(19) United States
(12) Patent Application Publication
(10) Pub. No.: US 2017/0147194 A1
(43) Pub. Date: May 25, 2017

(54) ELECTRONIC APPARATUS EQUIPPED WITH A TOUCH OPERATION SECTION

(71) Applicant: CASIO COMPUTER CO., LTD., Tokyo (JP)

(72) Inventor: Masanori ISHIHARA, Tokyo (JP)

(73) Assignee: CASIO COMPUTER CO., LTD., Tokyo (JP)

(21) Appl. No.: 15/278,516

(22) Filed: Sep. 28, 2016

(30) Foreign Application Priority Data
Nov. 19, 2015 (JP) 2015-226915

(51) Int. Cl. G06F 3/0488; H04N 5/232; G06F 3/041

(52) U.S. Cl. CPC G06F 3/04883; G06F 3/0416; H04N 5/23216

(57) ABSTRACT

When a touch operation is performed on a selfie pad, the slide amount of the touch operation is measured, and whether the touch operation is valid as a slide operation is judged in accordance with a function selected as an execution target from among a plurality of functions and the measured slide amount of the touch operation. Then, the selected function is controlled when the touch operation is valid as a slide operation.

### CROSS-REFERENCE TO RELATED APPLICATION

This application is based upon and claims the benefit of priority from the prior Japanese Patent Application No. 2015-226915, filed Nov. 19, 2015, the entire contents of which are incorporated herein by reference.

### BACKGROUND OF THE INVENTION

1. Field of the Invention

The present invention relates to an electronic apparatus equipped with a touch operation section, a touch operation control method and a storage medium.

2. Description of the Related Art

Conventionally, as a technology for an electronic apparatus equipped with a touch operation section allowing a touch operation such as a slide operation, a technology is known in which a slide sensor (touch operation section) is arranged on a side surface of the housing of an information terminal, as disclosed in Japanese Patent Application Laid-Open (Kokai) Publication No. 2013-238955. In this technology, in a case where a user viewing a display screen (touch screen) of the information terminal performs a touch operation with a thumb or the like while holding the housing of the information terminal with the right hand, the slide sensor can be operated only by the user sliding the thumb or the like along a side surface of the housing instead of operating a portion not easily reachable by a finger such as a corner of the display screen. As a result, a user interface that is excellent in operability can be provided.

### SUMMARY OF THE INVENTION

In accordance with one aspect of the present invention, there is provided an electronic apparatus comprising: a touch operation unit; and a processor that is configured to select one of a plurality of functions as an execution target function; measure a slide amount of a touch operation performed on the touch operation unit; judge whether the touch operation is valid as a slide operation in accordance with the selected function and the measured slide amount of the touch operation; and control the selected function when a judgment is made that the touch operation is a valid slide operation.

In accordance with another aspect of the present invention, there is provided a touch operation control method for an electronic apparatus including a touch operation unit, comprising: selecting one of a plurality of functions as an execution target function; measuring a slide amount of a touch operation performed on the touch operation unit; judging whether the touch operation is valid as a slide operation in accordance with the selected function and the measured slide amount of the touch operation; and controlling the selected function when a judgment is made that the touch operation is a valid slide operation.

In accordance with another aspect of the present invention, there is provided a non-transitory computer-readable storage medium having stored thereon a program that is executable by a computer of an electronic apparatus including a touch operation unit to actualize functions comprising: selecting one of a plurality of functions as an execution target function; measuring a slide amount of a touch operation performed on the touch operation unit; judging whether the touch operation is valid as a slide operation in accordance with the selected function and the measured slide amount of the touch operation; and controlling the selected function when a judgment is made that the touch operation is a valid slide operation.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings.

FIG. 1 is a block diagram showing basic components of an imaging apparatus (digital camera) in which the present invention has been applied as an electronic apparatus;

FIG. 2A is an external front view of the imaging apparatus, which shows a positional relation between a touch display section 6 and a selfie pad (touch operation section) 4b and a state where a frame block 11b has been closed with respect to a display block 11a and a lens block 11c;

FIG. 2B is a diagram showing the state in FIG. 2A from one side surface;

FIG. 3 is an external front view of the imaging apparatus, which shows a positional relation between the touch display section 6 and the selfie pad 4b and a state where the frame block 11b has been opened with respect to the display block 11a and the lens block 11c;

FIG. 4 is a diagram for describing a selfie pad judgment table 3C;

FIG. 5 is a schematic operation diagram for describing a state in which the operating status of the imaging apparatus makes a transition;

FIG. 6 is a flowchart for describing in detail processing in accordance with a slide operation (Step A14 of FIG. 5); and

FIG. 7A to FIG. 7E are diagrams exemplarily showing screens that are displayed on the touch display section 6 during processing in accordance with various functions.

### DETAILED DESCRIPTION OF THE PREFERRED EMBODIMENT

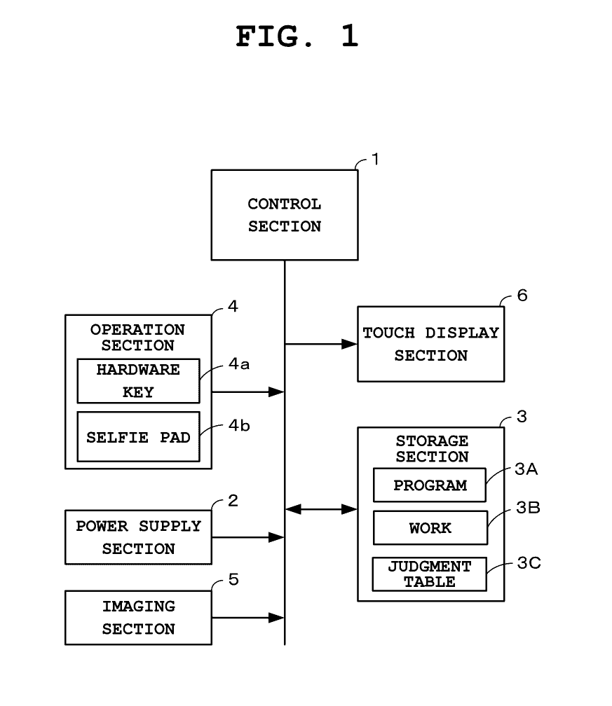

An embodiment of the present invention is described with reference to FIG. 1 to FIG. 7.

FIG. 1 is a block diagram showing basic components of an imaging apparatus (digital camera) in which the present invention has been applied as an electronic apparatus.

This imaging apparatus (digital camera) includes functions such as an imaging function capable of high-definition imaging of a photographic subject, a clock function for acquiring a current date and time and timer time, and an image playback function for reading and replaying a captured and recorded/stored image (stored image). A control section 1 in FIG. 1 operates by power supply from a power supply section (secondary battery) 2, and controls the entire operation of this imaging apparatus by following various programs stored in a storage section 3. This control section 1 is provided with a CPU (Central Processing Unit), a memory, and the like not shown in the drawing.

The storage section 3 is structured to include, for example, a ROM (Read Only Memory), a flash memory, and the like, and has a program memory 3A where a program for achieving the present embodiment and various applications are stored, a work memory 3B where a flag and the like are temporarily stored, and a selfie pad judgment table 3C described later. This storage section 3 may be structured to include a removable portable memory (recording medium) such as an SD (Secure Digital) card or a USB (Universal Serial Bus) memory, or may be structured to include, although not shown, a storage area on a predetermined server apparatus side in a case where the camera is connected to a network by a communication function.

An operating section 4 in FIG. 1 is structured to include hardware keys 4a and a selfie pad 4b. Although omitted in the drawing, the hardware keys 4a include various keys, such as a power supply key for power supply ON/OFF, a mode change key for switching, for example, between a mode for capturing images (REC mode) and a mode for replaying captured images (stored images) (PLAY mode), a function selection key for selecting, for each mode, any function for which a touch operation on the selfie pad 4b is enabled (“release”, “zoom adjustment”, and “image-quality adjustment” for “REC mode”, and “image forwarding” and “enlarged display” for “PLAY mode”), a release key for providing an instruction to perform image capturing, a telephoto key (zoom adjustment key), a wide-angle key (zoom adjustment key), and arrow keys for upward, downward, leftward, and rightward directions. For example, in accordance with an operation on the hardware keys 4a, the control section 1 performs mode change processing, image capture processing, zoom adjustment processing, and the like. The selfie pad 4b, which will be described in detail further below, is a touch operation section arranged on a side surface of a housing constituting the imaging apparatus, and is a user interface by which the user can perform a touch operation such as a tap operation or a slide operation with a finger while holding the housing by hand.

An imaging section 5 in FIG. 1 is capable of high-definition imaging of a photographic subject by forming a subject image from an optical lens at an image sensor such as a CCD (Charge-Coupled Device) or CMOS (Complementary Metal Oxide Semiconductor) not shown, and has a taking lens, the image sensor, a strobe, various sensors, an analog processing section, and a digital processing section. An image captured by the imaging section 5 is subjected to image compression processing in which the image is compressed by the control section 1 so as to be acquired as a file, and then recorded and stored in the recording medium of the storage section 3. A touch display section 6 in FIG. 1, in which a transparent touch operation section has been arranged and laminated on a display section such as a high-definition liquid crystal and various software keys (icons and touch keys) have been allocated and arranged thereon, displays function names of these software keys, and senses a touch operation by a finger or the like so as to input an operation signal in response to the touch operation. A display screen of the touch display section 6 serves as a monitor screen (live view screen) for displaying captured images (live view image) in real time or as a replay screen for replaying the captured images. Note that, although the touch display section 6 is used in the present embodiment, the present invention is not limited to thereto and a display section may be used which is constituted only by a liquid crystal without a laminated touch operation section.

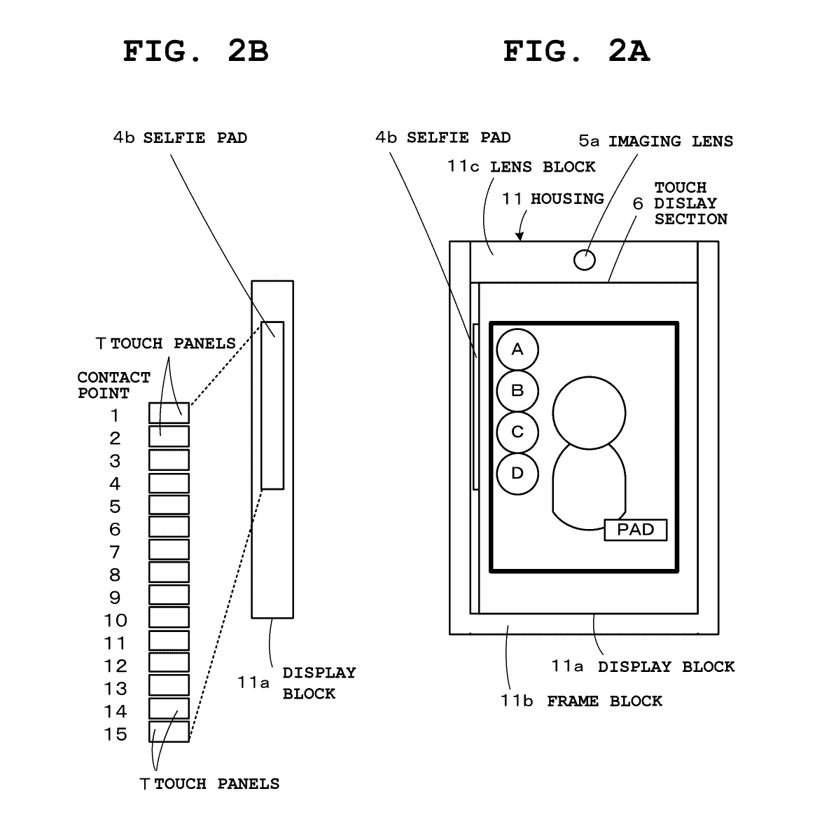

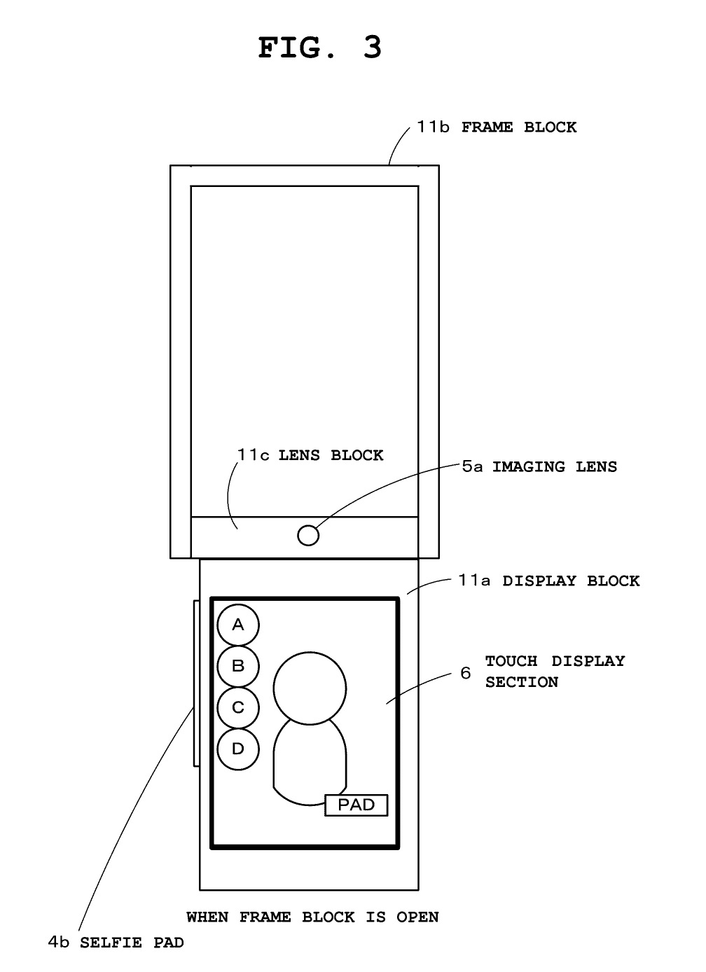

FIG. 2A, FIG. 2B, and FIG. 3 are external views of the imaging apparatus for showing a position relation between the touch display section 6 and the selfie pad (touch operation section) 4b.

FIG. 2A is a front view of the imaging apparatus, and FIG. 2B is a side view thereof. A housing 11 constituting the imaging apparatus has a thin rectangular display block 11a, a rectangular frame-shaped frame block 11b surrounding the perimeter of the display block 11a, and a lens block 11c which couples the display block 11a and the frame block 11b together. A center portion at one end of the display block 11a (an upper-end center portion in the example shown in the drawing) and a center portion at one end of the lens block 11c (a lower-end center portion in the example shown in the drawing) are rotatably attached in a lateral direction via a hinge section (omitted in the drawing) for lateral rotation.

Inner sides at both ends of the frame block 11b (upper-left and upper-right inner sides in the example shown in the drawing) and both ends of the lens block llc (left-side and right-side portions in the example shown in the drawing) are rotatably attached in a longitudinal direction via a hinge section (omitted in the drawing) for longitudinal rotation. The touch display section 6 is arranged at a center portion of the display block 11a. On one side portion thereof (left-side portions in the example shown in the drawing), the selfie pad 4b is arranged. At a center portion of the lens block 110, an imaging lens 5a which constitutes the imaging section 5 is arranged. As described above, the touch display section 6 on the display block 11a and the selfie pad 4b are arranged at different positions. Alternatively, the display block 11a and the lens block 11b may be integrated to form a main body block, and inner sides at both ends of the frame block 11b (upper-left and upper-right inner sides in the example shown in the drawing) and both ends of the main block (left-side and right-side portions in the example shown in the drawing) may be rotatably attached in a longitudinal direction via a hinge section (omitted in the drawing) for longitudinal rotation.

The selfie pad 4b is a touch operation section structured by a plurality of (fifteen in the present embodiment) small-piece-shaped touch panels T being arranged in one column. These touch panels T can be used as a fifteen-point switch and can be used on a curved surface. Note that numerals “1” to “15” added along the selfie pad 4b in the drawing for convenience of explanation indicate contact point numbers for identifying each touch panel T vertically aligned in a line. When the user performs a touch operation on the selfie pad 4b with a finger (for example, a thumb or an index finger) while holding the housing 11 by hand, an operation detection signal in accordance with the touch operation is provided to the control section 1. Then, based on the operation detection signal from the selfie pad 4b, the control section 1 judges the type of the touch operation performed on the selfie pad 4b, or in other words, judges whether a tap operation of tapping with a finger has been performed or a slide operation of moving a finger has been performed. When the operation is a tap operation, the control section 1 counts the number of successive tap operations. When the operation is a slide operation, the control section 1 measures its slide amount and slide direction.

The selfie pad 4b is capable of giving an instruction to perform unique processing for each function (for example, release, zoom adjustment, and image forwarding) selected as an execution target by a touch operation. When a touch operation is performed on the selfie pad 4b, the control section 1 judges whether the touch operation is a one-tap operation (single tap operation), a two-tap operation (double tap operation), or a slide operation, and performs processing in accordance with the touch operation. Here, the control section 1 measures the slide amount and the slide direction of the touch operation, refers to a selfie pad judgment table 3C based on the measurement result, and judges whether the touch operation is valid as a slide operation for a function selected as an execution target (selected function). When the touch operation is a valid slide operation, the control section 1 controls the selected function such as release, zoom adjustment, or image forwarding (performs processing corresponding to that function).

Also, when the touch operation is judged as a double tap operation, the control section 1 switches between a state where an operation for giving an instruction to perform processing unique to the function selected as an execution target on the selfie pad 4b is invalid (selfie pad limited state) and a state where an operation for giving an instruction to perform the unique processing is valid (selfie pad limitation released state). This switching is performed every time a double tap operation is performed. In the selfie pad limited state, even if a valid slide operation is performed on the selfie pad 4b, this operation is regarded as invalid, and the execution of the unique processing (for example, release, zoom adjustment, or image forwarding) is limited. In this limited state, only a double tap operation on the selfie pad 4b is valid. In the selfie pad limitation released state, the limitation on the unique processing is released, and all types of touch operations including a slide operation for giving an instructions to perform release, zoom adjustment, image forwarding, or the like are regarded as valid.

Note that, in the present embodiment, unique processing is not allocated to a single tap operation for each function in order to prevent erroneous operations. However, processing may be allocated to this single tap operation.

FIG. 2A and FIG. 2B depict the state in which the display block 11a has been accommodated in the frame block 11b (in a closed state), and FIG. 3 shows the state in which the frame block 11b has been rotated from the closed state in a longitudinal direction to be open with respect to the display block 11a and the lens block 11c, so that the apparatus is in a so-called selfie style in which the touch display section 6 and the imaging lens 5a have been oriented in the same direction. From this state, by the display block 11a being rotated in a lateral direction by 180 degrees, the apparatus can be in a normal photographing style in which the touch display section 6 and the imaging lens 5a have been oriented in opposite directions. On the touch display section 6 shown in the drawing, an image captured by the imaging section 5 (live view image) is displayed in real time. On this live view screen (monitor screen), various icons A to D for indicating types of image processing to be performed on the live view image are arranged and displayed.

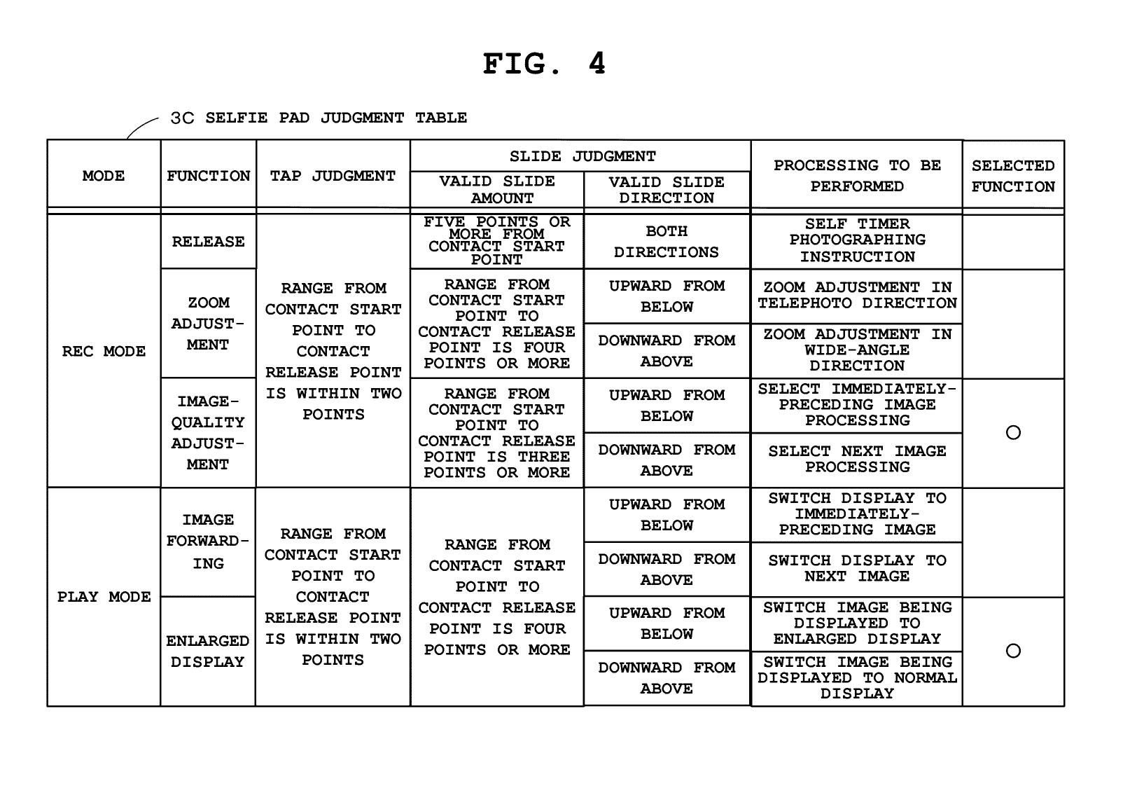

FIG. 4 is a diagram for describing the selfie pad judgment table 3C.

The selfie pad judgment table 3C is a table for specifying processing to be performed in accordance with a slide operation on the selfie pad 4b, and includes fields of “mode”, “function”, “touch judgment”, “slide judgment”, “processing to be performed”, and “selecting function”. The contents of the selfie pad judgment table 3C, such as “tap judgment” and “slide judgment”, can be arbitrarily changed by a user operation. “Mode” is a field for storing operation modes of the imaging apparatus. In the example shown in the drawing, “REC mode (imaging mode)” and “PLAY mode (replay mode)” have been stored. “Function” is a field for storing various functions that can be performed by a slide operation on the selfie pad 4b for each of the operation modes (REC mode and PLAY mode). In the example shown in the drawing, functions of “release”, “zoom adjustment”, and “image-quality adjustment” have been stored corresponding to “REC mode”, and functions of “image forwarding” and “enlarged display” have been stored corresponding to “PLAY mode”.

“Tap judgment” is a field for storing a reference value that is used for determining a touch operation performed on the selfie pad 4b as a valid tap operation. In the exampled shown in the drawing, “range from contact start point to contact release point (slide amount: amount of movement) is within two points” has been stored as a judgment reference value. In the selfie pad 4b, fifteen touch panels T vertically aligned in a line form a fifteen-point switch as shown in FIG. 2. One touch panel T is taken as one point (one contact point: one point).

Note that the slide amount (amount of movement) of a touch operation is measured by a difference between a contact start point and a contact release point of the touch operation, and a trace while the touch operation continues is not taken into consideration. This applies to “slide judgment” as well.

When the slide amount (amount of movement) of a touch operation is “within two points”, the control section 1 judges that the touch operation is valid as a tap operation. That is, even when the touched point is unintentionally slid (moved), if the slide amount (amount of movement) is short, the operation is regarded as a tap operation. Then, when a judgment is made that touch operations having slide amounts (amount of movement) equal to or less than two points have been consecutively performed twice, the control section 1 regards that a double tap operation has been performed.

“Slide judgment” is a field for storing a reference value for judging whether a touch operation performed on the selfie pad 4b in accordance with a function selected as an execution target is valid as a slide operation with respect to that function, which includes fields of “valid slide amount” and “valid slide direction”. “Valid slide amount” is a reference value for judging whether a slide operation is valid based on the slide amount of the slide operation, which is stored in association with each of a plurality of functions.

In the example shown in the drawing, as “valid slide amount” corresponding to each function of “REC mode”, “five points or more from contact start point” has been stored corresponding to “release”, “four points or more from contact start point” has been stored corresponding to “zoom adjustment”, and “three points or more from contact start point” has been stored corresponding to “image-quality adjustment. Also, as “valid slide amount” corresponding to each function of “PLAY mode”, “four points or more from contact start point” has been stored corresponding to “image forwarding” and “enlarged display”.

When a touch operation is performed on the selfie pad 4b with an arbitrary function being selected as an execution target, the control section 1 measures its slide amount, and judges whether the slide operation is valid based on whether the measured slide amount corresponds to “valid slide amount” associated with the selected function. This “valid slide amount” associated with each of a plurality of functions varies depending on the importance level of a corresponding function. For example, as the importance level of a function is higher, its “valid slide amount” is increased. In the example shown in the drawing, the level of function importance of “zoom adjustment” is higher than that of “image-quality adjustment”, and the level of function importance of “release” is higher than that of “zoom adjustment”. Therefore, “valid slide amounts” of “image-quality adjustment”, “zoom adjustment”, and “release” are set as “three points or more”, “four points or more”, and “five points or more”, respectively.

“Valid slide direction” in “slide judgment” is a reference value that is used to judge whether a slide operation is valid based on its direction. That is, in a case where a direction to one end of the selfie pad 4b in a longitudinal direction is an upward direction and a direction to the other end thereof is a downward direction, whether or not a slide operation is valid is judged based on whether the slide operation has been performed on the selfie pad 4b downward from above or been performed upward from below. “Valid slide direction” is stored in association with each of a plurality of functions. When one function includes a plurality of processing operations, “valid slide direction” is stored in association with each processing.

In the example shown in the drawing, as “valid slide direction” corresponding to each function of “REC mode”, “both directions” indicating that a slide direction can be either of “upward from below” and “downward from above” has been stored corresponding to “release”, and two directions, that is, “downward from above” and “upward from below” have been stored corresponding to “zoom adjustment” and “image adjustment”. Also, as for “PLAY mode”, two directions, that is, “downward from above” and “upward from below” have been stored corresponding to “image forwarding”, and two directions, that is, “downward from above” and “upward from below” have been stored corresponding to “enlarged display”. When a slide operation is performed on the selfie pad 4b with an arbitrary function being selected as an execution target, the control section 1 measures its slide direction, and judges whether this slide operation is valid based on whether the measured slide direction corresponds to “valid slide direction” corresponding to the selected function.

“Processing to be performed” is a field indicating processing that can be performed for each mode and function. “Function” and “processing to be performed” may have not only a one-to-one relation but also a one-to-N relation (N indicates the number of processing operations) if one function includes a plurality of processing operations. For example, as for “release” in “REC mode”, “function” and “processing to be performed” have a one-to-one relation. However, as for “zoom adjustment”, “image-quality adjustment”, “image forwarding”, and “enlarged display”, “function” and “processing to be performed” have a one-to-two relation. Also, “processing to be performed” has been associated with “valid slide amount” and “valid slide direction”. In a case where one function includes a plurality of processing operations, a different “valid slide amount” is associated with each “processing to be performed”.

In the example shown in the drawing, as for “processing to be performed” corresponding to each function in “REC mode”. “self timer photographing instruction” has been stored corresponding to “release” and “both directions”. “zoom adjustment in telephoto direction” has been stored corresponding to “zoom adjustment” and “upward from below”, “zoom adjustment in wide-angle direction” has been stored corresponding to “zoom adjustment” and “downward from above”, “select immediately-preceding image processing” has been stored corresponding to “image-quality adjustment” and “upward from below”, and “select next image processing” has been stored corresponding to “image-quality adjustment” and “downward from above”. Also, as for “processing to be performed” corresponding to each function in “PLAY mode”, “switch display to immediately-preceding image” has been stored corresponding to “image forwarding” and “upward from below”, “switch display to next image” has been stored corresponding to “image forwarding” and “downward from above”, “switch image being displayed to enlarged display” has been stored corresponding to “enlarged display” and “upward from below”, and “switch image being displayed to normal display” has been stored corresponding to “enlarged display” and “downward from above”.

“Selected function” is a field indicating “function” selected as an execution target for each mode. In the drawing, a circle indicates a function currently selected as an execution target. That is, in “REC mode” of the drawing. “image-quality adjustment” in “function” has been selected as an execution target. In “PLAY mode”, “enlarged display” in “function” has been selected as an execution target. A function to be selected as an execution target can be arbitrarily set for each mode by, for example, a user operation (such as a tap operation on the selfie pad 4b).

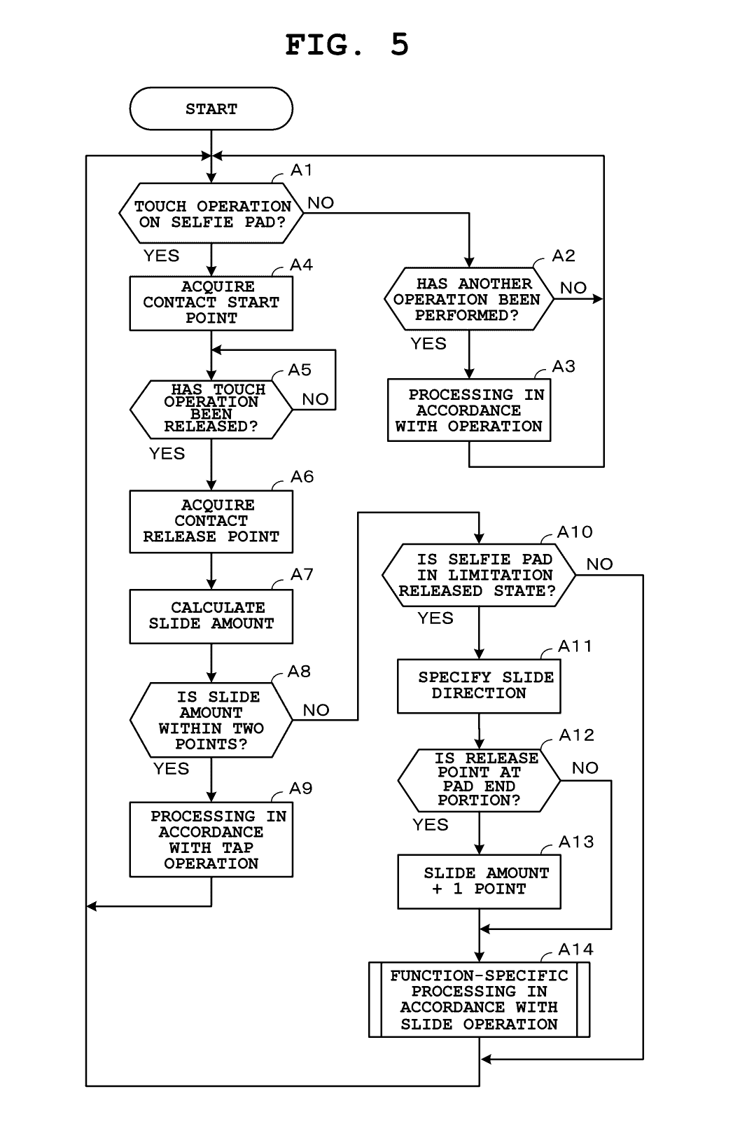

Next, the operation concept of the imaging apparatus according to the present embodiment is described with reference to a flowchart shown in FIG. 5. Here, each function described in the flowchart is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium.

FIG. 5 is a flowchart outlining an operation (characteristic operation of the present embodiment) of the imaging apparatus which is started upon power-up.

First, the control section 1 judges whether a touch operation has been performed on the selfie pad 4b (Step A1). When no touch operation has been performed on the selfie pad 4b (NO at Step A1), the control section 1 judges whether another operation has been performed (Step A2).

Here, when an operation other than that on the selfie pad 4b has been performed, that is, when one of the hardware keys 4a has been operated or a touch operation has been performed on the touch display section 6 (YES at Step A2), the control section 1 proceeds to processing in accordance with that operation (Step A3). For example, when the power supply key, a release key, a zoom adjustment key, or the like is operated, the control section 1 performs power supply ON/OFF processing, image capture processing, zoom adjustment processing, or processing for switching, for each of “REC mode” and “PLAY mode”, a function for which touch operations on the selfie pad 4b have been enabled.

Here, when a touch operation has been performed in the selfie pad limitation released state (YES at Step A1), the control section 1 acquires a first touched point on the selfie pad 4b as a contact start point (Step A4), and waits until the touch is released (Step A5). Then, when the touch operation is released (YES at Step A5), the control section 1 acquires a point that had been touched at this timing as a contact release point (Step A6). Then, the control section 1 calculates (measures) a range (difference) between the acquired contact start point and contact release point as a slide amount (the number of contact points: the number of points) (Step A7).

Then, the control section 1 refers to the selfie pad judgment table 3C, and compares “tap judgment” associated with a function selected as an execution target and the calculated slide amount so as to judge whether the calculated slide amount corresponds to the value of “tap judgment” (Step A8). Here, in the example of FIG. 4, “within two points” has been stored as “valid slide amount” in “tap judgment”. Accordingly, if the slide amount of the touch operation is “within two points” (YES at Step A8), the control section 1 regards the touch operation as a tap operation (single tap operation), and judges that the touch operation is valid as a single tap operation.

In this embodiment, processing in accordance with this single tap operation has not been set in the selfie pad judgment table 3C. Therefore, in processing in accordance with the tap operation at the next Step A9, the control section 1 performs processing of calculating the number of single tap operations and judging whether a two-tap operation (double tap operation) has been performed within a predetermined time. Initially, since the performed operation is a first tap operation, the control section 1 directly returns to Step A1 described above, and subsequently performs processing from Steps A1 to A8. Then, when the next touch operation is also a tap operation (YES at Step A8), in the above-described processing in accordance with tap operation, the control section 1 judges that a double tap operation has been performed, based on the number of the tap operations. (Step A9), and performs processing of switching between the selfie pad limitation released state and the selfie pad limited state. Then, the control section 1 returns to Step A1 described above.

On the other hand, when the calculated slide amount is “within two points” in “tap judgment” (NO at Step A8), the control section 1 judges whether switching to the selfie pad limitation released state has been performed (Step A10). Here, when judged that the apparatus is in the selfie pad limitation released state (YES at Step A1), the control section 1 specifies (measures) a direction from the contact start point to the contact release point as a slide direction (Step A11). Subsequently, in order to judge whether the touch operation is valid as a slide operation, the control section 1 judges whether the contact release point is on an end portion (upper end or lower end) of the selfie pad 4b (Step A12). When the contact release point is not on an end portion thereof (NO at Step A12), the control section 1 proceeds to function-specific processing in accordance with the slide operation (Step A14). When the contact release point of the slide operation is on an end portion of the selfie pad 4b (YES at Step A12), the control section 1 performs processing of updating the slide amount by adding one point to the calculated slide amount (Step A13), and then proceeds to the function-specific processing in accordance with the slide operation (Step A14). At Step A10, when the apparatus is not in the selfie pad limitation released state (NO at Step A10), since the slide operation is not valid irrespective of the slide amount, the control section 1 returns to Step A1 described above.

Here, the fact that the contact release point of the slide operation is on an end portion of the selfie pad 4b indicates that the slide operation has reached a possible upper limit value with respect to the slide direction. Although the user may think that he or she has performed a slide operation with a length exceeding the upper limit value, the actually calculated slide amount is shorter than that length. Therefore, the control section 1 adds “one point” to the calculated slide amount to update the value. Note that the addition value herein has been set at “one point” based on an assumption that, in general, the user can intuitively sense the position of an end (upper end or lower end) portion of the selfie pad 4b during a slide operation based on the arrangement position or size of the selfie pad 4b, the touch feeling, and the like and therefore the sliding finger hardly goes off the end portion significantly.

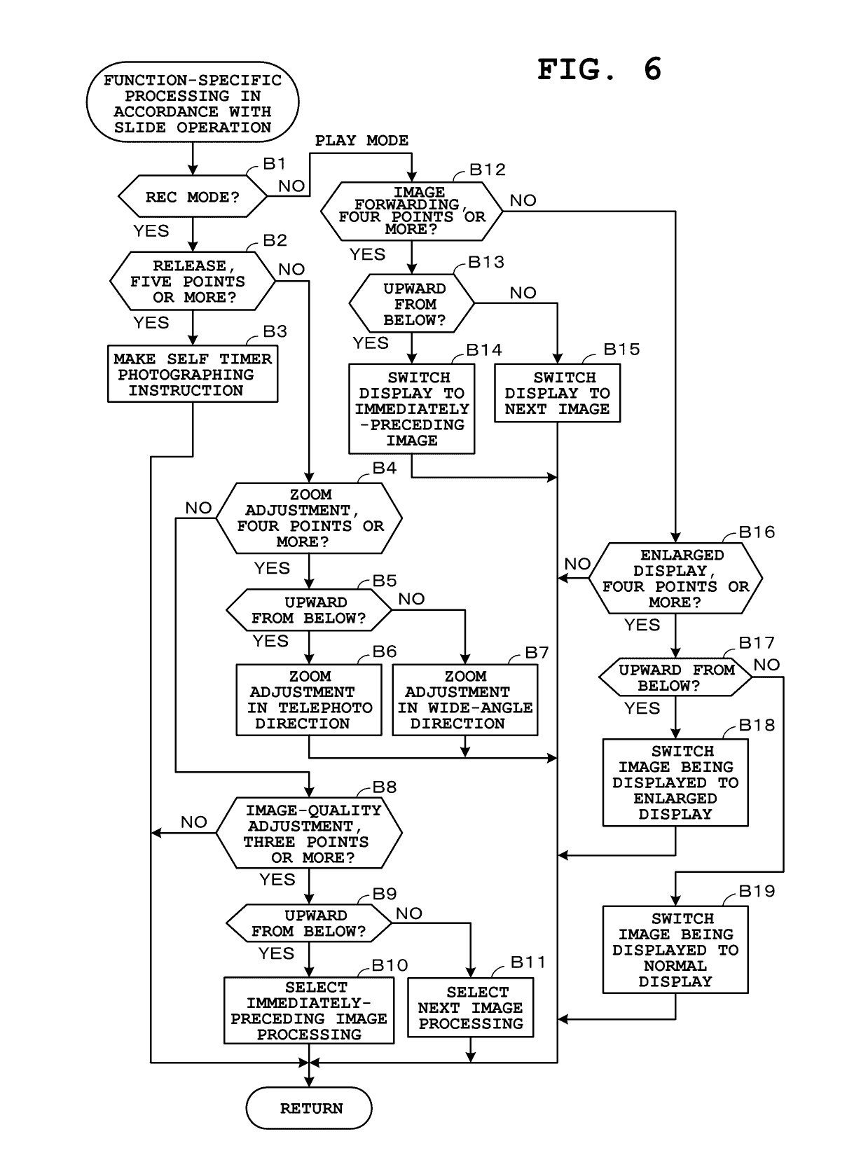

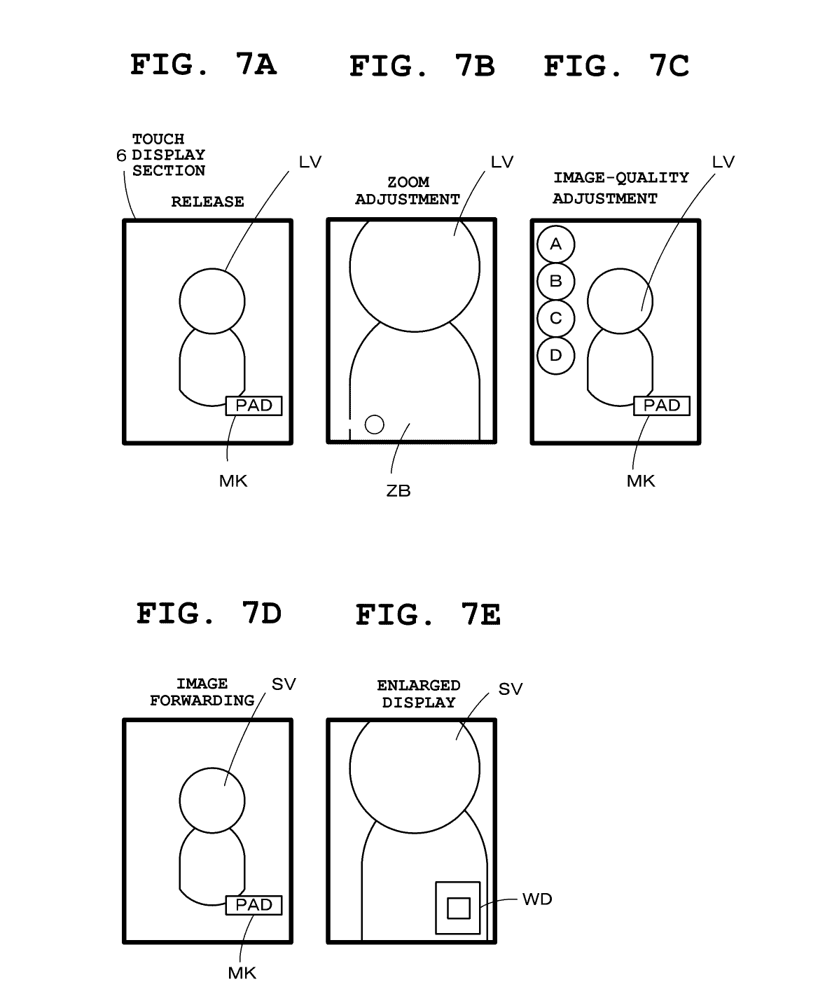

FIG. 6 is a flowchart for describing the above-described processing in accordance with slide operation (Step A14 of FIG. 5) in detail. In FIG. 6, the contents of the selfie pad judgment table 3c have been schematized. In the following descriptions, the processing in accordance with slide operation is briefly and specifically described with reference to display examples corresponding to various functions shown in FIG. 7A to 7E.

First, in “REC mode” (YES at Step B1), the control section 1 displays a live view image on the monitor screen (touch display section 6). FIG. 7A shows a display example in this case. On the monitor screen, a mark MK of “PAD” for recognizing the selfie pad limitation released state and a live view image LV are displayed. In this case, when “function” selected as an execution target is “release” and a calculated slide amount is “five points or more” in “valid slide amount” (YES at Step B2), the control section 1 judges that the slide operation is valid for “release”, and provides a self timer photographing instruction (Step B3).

When “zoom adjustment” has been selected as an execution target function, a zoom bar ZB for scale display of enlargement/reduction is displayed on the monitor screen together with the live view image LV as shown in FIG. 7B. When a selected function is “zoom adjustment” as described above, if a calculated slide amount is “four points or more” in “valid slide amount” (YES at Step B4) and “valid slide direction” is “upward from below” (YES at Step B5), the control section 1 performs zoom adjustment processing in a telephoto direction (Step B6). If “valid slide direction” is “downward from above” (NO at Step B5), the control section 1 performs zoom adjustment processing in a wide-angle direction (Step B7).

When “image-quality adjustment” has been selected as an execution target function, various icons A to D indicating image quality levels and the “PAD” mark MK are displayed on the monitor screen together with the live view image LV as shown in FIG. 7C. When a selected function is “image-quality adjustment” as described above, if a calculated slide amount is “three points or more” in “valid slide amount” (YES at Step B8) and “valid slide direction” is “upward from below” (YES at Step B9), the control section 1 selects the immediately-preceding image processing (Step B10). If “valid slide direction” is “downward from above” (NO at Step B9), the control section 1 selects the next image processing (Step B11).

In “REC mode”, when judgment results at Step B2 and Step B4 are “NO”, that is, when “function” selected as an execution target is “release” and a calculated slide amount is “(larger than two points and) smaller than five points” in “valid slide amount” or when “function” selected as an execution target is “zoom adjustment” and a calculated slide amount is “(larger than two points and) smaller than four points” in “valid slide amount”, the control section 1 does not regard the current operation as a tap operation or slide operation, and does not perform any processing.

On the other hand, in “PLAY mode” (NO at Step B12), the control section 1 reads out a captured image (stored image) and displays it on a replay screen (touch display section 6). Here, when “function” selected as an execution target is “image forwarding”, the “PAD” mark MK and the captured image SV are displayed on the replay screen of the touch display section 6 as shown in FIG. 7D. When a selected function is “image forwarding” as described above, if a calculated slide amount is “four points or more” in “valid slide amount” (YES at Step B12) and “valid slide direction” is “upward from below” (YES at Step B13), the control section 1 switches display to the immediately-preceding image (Step B14). If “valid slide direction” is “downward from above” (NO at Step B13), the control section 1 switches display to the next image (Step B15).

In “PLAY mode” (NO at Step B12), when “enlarged display” has been selected as “function” as an execution target, an enlarged captured image SV and an enlarged portion window WD for guiding the user as to which portion of the captured image is enlarged are displayed as shown in FIG. 7E. When a selected function is “enlarged display” as described above, if a calculated slide amount is “four points or more” in “valid slide amount” (YES at Step B16) and “valid slide direction” is “upward from below” (YES at Step B17), the control section 1 switches an image being displayed to enlarged display (Step B18). If “valid slide direction” is “downward from above” (NO at Step B17), the control section 1 switches the image being displayed to normal display (Step B19). In “PLAY mode”, when a judgment result at Step B16 is “NO”, that is, when a calculated slide amount is “(larger than two points and) smaller than four points” in “valid slide amount”, the control section 1 does not regard the current operation as a tap operation or a slide operation, and does not perform any processing.

As described above, in the present embodiment, when a touch operation is performed on the selfie pad 4b, the control section 1 measures the slide amount of the touch operation, judges whether the touch operation is valid as a slide operation based on a function selected from a plurality of functions and the measured slide amount, and controls the selected function when the touch operation is valid as a slide operation. As a result of this configuration, the operability of touch operation can be improved by appropriately performing touch operation control in accordance with a function selected as an execution target.

Also, the control section 1 judges whether a touch operation is valid as a slide operation, based on whether a measured slide amount corresponds to “valid slide amount” corresponding to a function selected as an execution target. As a result of this configuration, by appropriate “valid slide amount” being associated with each function, the operability of touch operation can be improved.

Moreover, the valid slide amount of the present embodiment varies in accordance with the importance level of a function associated therewith. As a result of this configuration, for example, by setting such that a valid slide amount is increased when the importance level of a function is high, the operability of touch operation can be improved.

Furthermore, in the case where “valid slide direction” has been further associated with each of a plurality of functions as information indicating whether slide operations on the selfie pad judgment table 3C are valid, the control section 1 further judges whether a slide operation is valid based on whether a measured slide direction corresponds to “valid slide direction” corresponding to a function selected as an execution target. As a result of this configuration, by appropriate “valid slide direction” being associated with each function, the operability of touch operation can be improved.

Still further, in the case where different directions have been associated as “valid slide directions” with a plurality of processing operations included in one function, the control section 1 judges whether a touch operation is valid as a slide operation based on whether a measured slide direction corresponds to one of “valid slide directions” associated with the plurality of processing operations included in that function. As a result of this configuration, a plurality of processing operations included in one function can be controlled for each corresponding slide direction.

Yet still further, the control section 1 judges that a touch operation is valid as a slide operation even when a measured slide amount is shorter than a valid slide amount, on condition that the measured slide amount is equal to a touch-operation-possible upper-limit slide amount with respect to a slide direction. As a result of this configuration, even when a measured slide amount is smaller than a valid slide amount, the touch operation can be judged as a valid slide operation if the reason therefor is a matter of being on the selfie pad 4b.

Yet still further, when a touch operation that reaches an end portion of the selfie pad 4b is performed, the control section 1 adds a predetermined value to a measured slide amount and, on condition that the addition value corresponds to a valid slide amount, judges that the touch operation is valid as a slide operation. As a result of this configuration, when a touch operation reaches an end portion of the selfie pad 4b and whereby a measured slide amount is smaller than a valid slide amount, whether the touch operation is valid as a slide operation can be judged by using a relevant coping method.

Yet still further, even if the slide amount of a measured touch operation is not 0 (zero) but within a predetermined slide amount (for example, two points), the control section 1 judges that the touch operation is valid as a tap operation. As a result of this configuration, processing in accordance with a tap operation can be performed even if a touching finger or the like is unintentionally slid (moved) during a touch operation.

Yet still further, when a measured slide amount of a slide operation is three points between a valid slide amount (for example, four points) and a predetermined slide amount (for example, two points), the control section 1 judges that the slide operation is invalid. As a result of this configuration, erroneous operations can be reduced and the operability of touch operation can be improved.

Yet still further, when a touch operation is judged as a valid slide operation, the control section 1 performs processing unique to a function selected as an execution target. As a result of this configuration, the operability of touch operation can be improved in accordance with a selected function.

In the above-described embodiment. “release” and “both directions” are stored as “valid slide direction”. However, only one of “downward from above” and “upward from below” may be stored. In this case, even when a touch operation has a valid slide amount, if its direction is opposite to a stored direction, the touch operation is judged as invalid.

Also, in the above-described embodiment, a selection from among “release”, “zoom adjustment”, and “image-quality adjustment” in “REC mode” and “image forwarding” and “enlarged display” in “PLAY mode” is made by a function change key of the hardware keys 4a of the operating unit 4. However, this mode-specific function selection may be made by using the touch display section 6.

Moreover, in the above-described embodiment, when a slide operation that reaches an end portion of the selfie pad 4b is performed, a predetermined value is added to a measured slide amount, and the slide operation is judged as valid on condition that the addition value corresponds to a valid slide amount. However, without adding a predetermined value to the measured slide amount, the valid slide amount may be decreased by “one point” to judge whether the slide operation is valid.

Furthermore, in the above-described embodiment. “tap judgment” and “slide judgment” are stored in association with all functions, as shown in the selfie pad judgment table of FIG. 4. However, “tap judgment” and “slide judgment” may be stored only for a predetermined function. Also, either one of “tap judgment” and “slide judgment” may be stored only for a predetermined function. That is, as a matter of course, the present invention is not limited to the selfie pad judgment table of FIG. 4.

Still further, in the above-described embodiment, the selfie pad 4b is arranged on one side portion of the housing 11. However, it may be arranged at another position, such as a back surface portion of the housing 11 which is a position difficult for the user to visually capture at the time of a normal operation.

Yet still further, in the above-described embodiment, fifteen small-piece-shaped touch panels T are vertically aligned in a line to form the selfie pad 4b. However, the number of the touch panels T may be arbitrarily determined. In addition, two selfie pads 4b may be arranged in parallel with each other, may be vertically arranged with a space, or may be arranged in a cross shape. Furthermore, the touch panels T are not limited to be arranged linearly, but may be arranged in a curved shape in accordance with the shape of the housing.

Yet still further, in the above-described embodiment, the present invention has been exemplarily applied in an imaging apparatus (digital camera) that is an electronic apparatus. However, the present invention may be applied in a personal computer, a PDA (Personal Digital Assistance), a tablet terminal, a portable telephone such as a smartphone, an electronic game machine, a music player, and the like.

Yet still further, the “apparatus” and “sections” described in the above-described embodiment are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An electronic apparatus comprising:
a touch operation unit; and
a processor that is configured to select one of a plurality of functions as an execution target function; measure a slide amount of a touch operation performed on the touch operation unit; judge whether the touch operation is valid as a slide operation in accordance with the selected function and the measured slide amount of the touch operation; and control the selected function when a judgment is made that the touch operation is a valid slide operation.

2. The electronic apparatus according to claim 1, wherein the processor judges whether the touch operation is valid as a slide operation based on whether the measured slide amount of the touch operation corresponds to a valid slide amount associated with the selected function.

3. The electronic apparatus according to claim 2, wherein the processor judges whether the touch operation is valid as a slide operation based on whether the measured slide amount of the touch operation corresponds to a valid slide amount which has been associated with the selected function and varies in accordance with an importance level of the function with which the valid slide amount has been associated.

4. The electronic apparatus according to claim 1, wherein the processor further measures a slide direction of the touch operation performed on the touch operation unit, and judges whether the touch operation is valid as a slide operation based on whether the measured slide direction of the touch operation corresponds to a valid slide direction associated with the selected function.

5. The electronic apparatus according to claim 4, wherein the processor judges whether the touch operation is valid as a slide operation based on whether the measured slide direction of the touch operation corresponds to one of valid slide directions associated with a plurality of processing operations that are performed by the selected function.

6. The electronic apparatus according to claim 2, wherein the processor judges that the touch operation is valid as a slide operation on condition that the measured slide amount of the touch operation is an operation-possible upper-limit slide amount with respect to a slide direction of the touch operation, even when the measured slide amount is smaller than the valid slide amount associated with the selected function.

7. The electronic apparatus according to claim 6, wherein the processor adds a predetermined value to the measured slide amount when the touch operation on the touch operation unit reaches an end portion of the touch operation unit, and judges that the touch operation is valid as a slide operation on condition that a value acquired by the addition corresponds to the valid slide amount associated with the selected function.

8. The electronic apparatus according to claim 1, wherein the processor judges that the touch operation is valid as a tap operation when the measured slide amount of the touch operation is not 0 but within a predetermined slide amount.

9. The electronic apparatus according to claim 8, wherein the processor judges that the touch operation is invalid when the measured slide amount of the touch operation is a slide amount between the valid slide amount and the predetermined slide amount.

10. The electronic apparatus according to claim 1, wherein the processor performs control of executing processing unique to the selected function when the touch operation is judged to be a valid slide operation.

11. A touch operation control method for an electronic apparatus including a touch operation unit, comprising:
selecting one of a plurality of functions as an execution target function;
measuring a slide amount of a touch operation performed on the touch operation unit;
judging whether the touch operation is valid as a slide operation in accordance with the selected function and the measured slide amount of the touch operation; and
controlling the selected function when a judgment is made that the touch operation is a valid slide operation.

12. A non-transitory computer-readable storage medium having stored thereon a program that is executable by a computer of an electronic apparatus including a touch operation unit to actualize functions comprising:
selecting one of a plurality of functions as an execution target function;
measuring a slide amount of a touch operation performed on the touch operation unit;
judging whether the touch operation is valid as a slide operation in accordance with the selected function and the measured slide amount of the touch operation; and
controlling the selected function when a judgment is made that the touch operation is a valid slide operation.
